(19) United States
(12) Patent Application Publication
(10) Pub. No.: US 2016/0174251 A1
(43) Pub. Date: Jun. 16, 2016

(54) Information Transmission Method, Information Determining Method, and Apparatus in TDD System, and System

(71) Applicant: Huawei Technology Co., Ltd., Shenzhen (CN)

(72) Inventors: Ningbo Zhang, Shenzhen (CN); Zheng Yu, Beijing (CN); Fang Nan, Beijing (CN); Xingqing Cheng, Beijing (CN)

(21) Appl. No.: 15/050,341

(22) Filed: Feb. 22, 2016

Related U.S. Application Data
(63) Continuation of application No. PCT/CN2013/082215, filed on Aug. 23, 2013.

(51) Int. Cl. H04W 72/12; H04L 5/14; H04L 5/00; H04W 72/04

(52) U.S. Cl. CPC H04W 72/1289; H04W 72/042; H04W 72/0446; H04L 5/14; H04L 5/0048; H04W 88/02

(57) ABSTRACT

The present invention provides an information transmission method, an information determining method, and an apparatus in a TDD system, and a system. In the method, first information is mapped onto multiple preset subframes in a radio frame, where the multiple preset subframes include at least a subframe 0 and a subframe 5, and the first information is system information or scheduling information of the system information; then a first physical channel is sent to user equipment UE, where the first physical channel carries the first information, so that the UE can detect the first physical channel in multiple preset subframes, and determine the first information, thereby decreasing detection complexity and power consumption of the UE.

This application is a continuation of International Application No. PCT/CN2013/082215, filed on Aug. 23, 2013, which application is hereby incorporated herein by reference.

### TECHNICAL FIELD

Embodiments of the present invention relate to communications technologies, and in particular, to an information transmission method, an information determining method, and an apparatus in a TDD system, and a system.

### BACKGROUND

In a Long Term Evolution (LTE) or Long Term Evolution Advanced (LTE-A) system, after startup, user equipment (UE) first detects a synchronization signal, and then detects a physical broadcast channel (PBCH) to obtain a master information block (MIB); then, the UE detects a physical downlink control channel (PDCCH) to obtain scheduling information of a system information block type 1 (SIB1), and then detects a physical downlink shared channel (PDSCH) according to the scheduling information to obtain the SIB1. In addition, one or more other system information blocks (SIB) except the SIB1 are encapsulated in a system information (SI) message. The UE detects the PDCCH to obtain scheduling information of the SI, and then detects the PDSCH according to the scheduling information to obtain the SI or another SIB.

In an existing LTE or LTE-A system, a PBCH carrying a MIB, a PDCCH for scheduling a SIB1, a PDSCH carrying a SIB1, a PDCCH for scheduling SI, or a PDSCH carrying SI is transmitted in one subframe.

In consideration of coverage enhancement, transmission reliability needs to be enhanced for the PBCH carrying a MIB, the PDCCH for scheduling a SIB1, the PDSCH carrying a SIB1, the PDCCH for scheduling SI, or the PDSCH carrying SI, so as to expand coverage; in this way, an enhanced PBCH, an enhanced PDCCH (for scheduling a SIB1 or SI), and an enhanced PDSCH (carrying a SIB1 or SI) are transmitted in multiple subframes.

For a TDD system, UE needs to perform blind detection on an enhanced PBCH, an enhanced PDCCH (for scheduling a SIB1 or SI), and an enhanced PDSCH (carrying a SIB1 or SI), to obtain carried information; however, blind detection by the UE increases detection complexity and power consumption of the UE.

### SUMMARY

Embodiments of the present invention provide an information transmission method, an information determining method, and an apparatus in a TDD system, and a system, so as to decrease detection complexity and power consumption of UE.

According to a first aspect, an embodiment of the present invention provides an information transmission method in a TDD system, including:

mapping first information onto multiple preset subframes in a radio frame, where the multiple preset subframes include at least a subframe 0 and a subframe 5, and the first information is system information or scheduling information of system information; and

sending a first physical channel to user equipment UE, where the first physical channel carries the first information.

In a first possible implementation manner, the multiple preset subframes further include either of a subframe 1 and a subframe 6.

In a second possible implementation manner, the multiple preset subframes further include a subframe 1 and a subframe 6.

With reference to any one of the first aspect to the second possible implementation manner of the first aspect, in a third possible implementation manner, the multiple preset subframes further include at least one of a subframe 3, a subframe 4, a subframe 7, a subframe 8, and a subframe 9.

With reference to the first aspect or the third possible implementation manner of the first aspect, in a fourth possible implementation manner, the multiple subframes further include the subframe 3, the subframe 4, the subframe 7, the subframe 8, and the subframe 9.

In a fifth possible implementation manner, the multiple preset subframes are all downlink subframes in a radio frame that is determined by a pre-stipulated uplink-downlink configuration; or

the multiple preset subframes further include all special subframes in a radio frame that is determined by a pre-stipulated uplink-downlink configuration; or

the multiple preset subframes further include all downlink subframes and special subframes, except a subframe 0 and a subframe 5, in a radio frame that is determined by a pre-stipulated uplink-downlink configuration; or

the multiple preset subframes are all subframes in the radio frame.

With reference to the fifth possible implementation manner of the first aspect, in a sixth possible implementation manner, that the multiple preset subframes further include all downlink subframes and special subframes, except a subframe 0 and a subframe 5, in a radio frame that is determined by a pre-stipulated uplink-downlink configuration includes:

the multiple preset subframes further include all downlink subframes and special subframes, except a subframe 0 and a subframe 5, in a radio frame that is determined by a pre-stipulated uplink-downlink configuration 5.

With reference to any one of the first aspect to the sixth possible implementation manner of the first aspect, in a seventh possible implementation manner, a configuration of the special subframe is a pre-stipulated special subframe configuration.

With reference to the seventh possible implementation manner of the first aspect, in an eighth possible implementation manner, for a downlink normal cyclic prefix, the configuration of the special subframe is a pre-stipulated special subframe configuration 4, and for a downlink extended cyclic prefix, the configuration of the special subframe is a pre-stipulated special subframe configuration 3.

With reference to the seventh possible implementation manner of the first aspect or the eighth possible implementation manner of the first aspect, in a ninth possible implementation manner, the special subframe is the subframe 1 and/or the subframe 6.

With reference to any one of the first aspect to the ninth possible implementation manner of the first aspect, in a tenth possible implementation manner, after sending a first physical channel to user equipment UE, the method further includes:

sending a second physical channel to the UE, where an uplink-downlink configuration of a radio frame for transmitting the second physical channel is different from an uplink-downlink configuration of the radio frame for transmitting the first information, and/or, a special subframe configuration of a special subframe in the radio frame for transmitting the second physical channel is different from a special subframe configuration of a special subframe in the radio frame for transmitting the first information; and the second physical channel includes any one of a physical downlink control channel PDCCH, an enhanced physical downlink control channel ePDCCH, a physical control format indicator channel PCFICH, a physical hybrid automatic repeat request indicator channel PHICH, and a physical downlink shared channel PDSCH.

With reference to any one of the first aspect to the tenth possible implementation manner of the first aspect, in an eleventh possible implementation manner, the system information is at least one of a master information block MIB, a master information block of a new UE category, a master information block of a new UE type, a master information block of coverage-enhanced UE, a master information block of delay-tolerant UE, and a machine type communication master information block MTC MIB; and

the first physical channel is a physical broadcast channel PBCH carrying the system information, and/or an enhanced PBCH carrying the system information.

With reference to any one of the first aspect to the tenth possible implementation manner of the first aspect, in a twelfth possible implementation manner, the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and

the first physical channel is a physical downlink shared channel PDSCH carrying the system information, and/or an enhanced PDSCH carrying the system information.

With reference to any one of the first aspect to the twelfth possible implementation manner of the first aspect, in a thirteenth possible implementation manner, the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SIB; and

the first physical channel is a physical downlink control channel PDCCH carrying the scheduling information, and/or an enhanced PDCCH carrying the scheduling information.

According to a second aspect, an embodiment of the present invention provides an information determining method in a TDD system, including:

receiving a first physical channel in multiple preset subframes in a radio frame, where the multiple preset subframes include at least a subframe 0 and a subframe 5, the first physical channel carries first information, and the first information is system information or scheduling information of system information; and

determining the first information according to the received first physical channel.

In a first possible implementation manner, the multiple preset subframes further include either of a subframe 1 and a subframe 6.

In a second possible implementation manner, the multiple preset subframes further include a subframe 1 and a subframe 6.

With reference to any one of the second aspect to the second possible implementation manner of the second aspect, in a third possible implementation manner, the multiple preset subframes further include at least one of a subframe 3, a subframe 4, a subframe 7, a subframe 8, and a subframe 9.

With reference to the second aspect or the third possible implementation manner of the second aspect, in a fourth possible implementation manner, the multiple preset subframes further include the subframe 3, the subframe 4, the subframe 7, the subframe 8, and the subframe 9.

In a fifth possible implementation manner, the multiple preset subframes are all downlink subframes in a radio frame that is determined by a pre-stipulated uplink-downlink configuration; or

the multiple preset subframes further include all special subframes in a radio frame that is determined by a pre-stipulated uplink-downlink configuration; or

the multiple preset subframes further include all downlink subframes and special subframes, except a subframe 0 and a subframe 5, in a radio frame that is determined by a pre-stipulated uplink-downlink configuration; or

the multiple preset subframes are all subframes in the radio frame.

With reference to the fifth possible implementation manner of the second aspect, in a sixth possible implementation manner, that the multiple preset subframes further include all downlink subframes and special subframes, except a subframe 0 and a subframe 5, in a radio frame that is determined by a pre-stipulated uplink-downlink configuration includes:

the multiple preset subframes further include all downlink subframes and special subframes, except a subframe 0 and a subframe 5, in a radio frame that is determined by a pre-stipulated uplink-downlink configuration 5.

With reference to any one of the second aspect to the sixth possible implementation manner of the second aspect, in a seventh possible implementation manner, a configuration of the special subframe is a pre-stipulated special subframe configuration.

With reference to the seventh possible implementation manner of the second aspect, in an eighth possible implementation manner, for a downlink normal cyclic prefix, the configuration of the special subframe is a pre-stipulated special subframe configuration 4, and for a downlink extended cyclic prefix, the configuration of the special subframe is a pre-stipulated special subframe configuration 3.

With reference to the seventh possible implementation manner of the second aspect or the eighth possible implementation manner of the first aspect, in a ninth possible implementation manner, the special subframe is the subframe 1 and/or the subframe 6.

With reference to any one of the second aspect to the ninth possible implementation manner of the second aspect, in a tenth possible implementation manner, after the receiving a first physical channel in multiple preset subframes in a radio frame, the method further includes:

receiving a second physical channel, where an uplink-downlink configuration of a radio frame for transmitting the second physical channel is different from an uplink-downlink configuration of the radio frame for transmitting the first information, and/or, a special subframe configuration of a special subframe in the radio frame for transmitting the second physical channel is different from a special subframe configuration of a special subframe in the radio frame for transmitting the first information; and the second physical channel includes any one of a physical downlink control channel PDCCH, an enhanced physical downlink control channel ePDCCH, a physical control format indicator channel PCFICH, a physical hybrid automatic repeat request indicator channel PHICH, and a physical downlink shared channel PDSCH.

With reference to any one of the second aspect to the tenth possible implementation manner of the second aspect, in an eleventh possible implementation manner, the system information is at least one of a master information block MIB, a master information block of a new UE category, a master information block of a new UE type, a master information block of coverage-enhanced UE, a master information block of delay-tolerant UE, and a machine type communication master information block MTC MIB; and

the first physical channel is a physical broadcast channel PBCH carrying the system information, and/or an enhanced PBCH carrying the system information.

With reference to any one of the second aspect to the tenth possible implementation manner of the second aspect, in a twelfth possible implementation manner, the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and

the first physical channel is a physical downlink shared channel PDSCH carrying the system information, and/or an enhanced PDSCH carrying the system information.

With reference to any one of the second aspect to the twelfth possible implementation manner of the second aspect, in a thirteenth possible implementation manner, the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SIB; and

the first physical channel is a physical downlink control channel PDCCH carrying the scheduling information, and/or an enhanced PDCCH carrying the scheduling information.

According to a third aspect, an embodiment of the present invention provides an information transmission apparatus in a TDD system, including:

a mapping module, configured to map first information onto multiple preset subframes in a radio frame, where the multiple preset subframes include at least a subframe 0 and a subframe 5, and the first information is system information or scheduling information of system information; and

a sending module, configured to send a first physical channel to user equipment UE, where the first physical channel carries the first information.

In a first possible implementation manner, the multiple preset subframes further include either of a subframe 1 and a subframe 6.

In a second possible implementation manner, the multiple preset subframes further include a subframe 1 and a subframe 6.

With reference to any one of the third aspect to the second possible implementation manner of the third aspect, in a third possible implementation manner, the multiple preset subframes further include at least one of a subframe 3, a subframe 4, a subframe 7, a subframe 8, and a subframe 9.

With reference to the third aspect or the third possible implementation manner of the third aspect, in a fourth possible implementation manner, the multiple subframes further include the subframe 3, the subframe 4, the subframe 7, the subframe 8, and the subframe 9.

In a fifth possible implementation manner, the multiple preset subframes are all downlink subframes in a radio frame that is determined by a pre-stipulated uplink-downlink configuration; or

the multiple preset subframes further include all special subframes in a radio frame that is determined by a pre-stipulated uplink-downlink configuration; or

the multiple preset subframes further include all downlink subframes and special subframes, except a subframe 0 and a subframe 5, in a radio frame that is determined by a pre-stipulated uplink-downlink configuration; or

the multiple preset subframes are all subframes in the radio frame.

With reference to the fifth possible implementation manner of the third aspect, in a sixth possible implementation manner, that the multiple preset subframes further include all downlink subframes and special subframes, except a subframe 0 and a subframe 5, in a radio frame that is determined by a pre-stipulated uplink-downlink configuration includes:

the multiple preset subframes further include all downlink subframes and special subframes, except a subframe 0 and a subframe 5, in a radio frame that is determined by a pre-stipulated uplink-downlink configuration 5.

With reference to any one of the third aspect to the sixth possible implementation manner of the third aspect, in a seventh possible implementation manner, a configuration of the special subframe is a pre-stipulated special subframe configuration.

With reference to the seventh possible implementation manner of the third aspect, in an eighth possible implementation manner, for a downlink normal cyclic prefix, the configuration of the special subframe is a pre-stipulated special subframe configuration 4, and for a downlink extended cyclic prefix, the configuration of the special subframe is a pre-stipulated special subframe configuration 3.

With reference to the seventh possible implementation manner of the third aspect or the eighth possible implementation manner of the third aspect, in a ninth possible implementation manner, the special subframe is the subframe 1 and/or the subframe 6.

With reference to any one of the third aspect to the ninth possible implementation manner of the third aspect, in a tenth possible implementation manner, the sending module is further configured to send a second physical channel to the UE, where an uplink-downlink configuration of a radio frame for transmitting the second physical channel is different from an uplink-downlink configuration of the radio frame for transmitting the first information, and/or, a special subframe configuration of a special subframe in the radio frame for transmitting the second physical channel is different from a special subframe configuration of a special subframe in the radio frame for transmitting the first information; and the second physical channel includes any one of a physical downlink control channel PDCCH, an enhanced physical downlink control channel ePDCCH, a physical control format indicator channel PCFICH, a physical hybrid automatic repeat request indicator channel PHICH, and a physical downlink shared channel PDSCH.

With reference to any one of the third aspect to the tenth possible implementation manner of the third aspect, in an eleventh possible implementation manner, the system information is at least one of a master information block MIB, a master information block of a new UE category, a master information block of a new UE type, a master information block of coverage-enhanced UE, a master information block of delay-tolerant UE, and a machine type communication master information block MTC MIB; and the first physical channel is a physical broadcast channel PBCH carrying the system information, and/or an enhanced PBCH carrying the system information.

With reference to any one of the third aspect to the tenth possible implementation manner of the third aspect, in a twelfth possible implementation manner, the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and

the first physical channel is a physical downlink shared channel PDSCH carrying the system information, and/or an enhanced PDSCH carrying the system information.

With reference to any one of the third aspect to the twelfth possible implementation manner of the third aspect, in a thirteenth possible implementation manner, the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SIB; and

the first physical channel is a physical downlink control channel PDCCH carrying the scheduling information, and/or an enhanced PDCCH carrying the scheduling information.

According to a fourth aspect, an embodiment of the present invention provides an information determining apparatus in a TDD system, including:

a receiving module, configured to receive a first physical channel in multiple preset subframes in a radio frame, where the multiple preset subframes include at least a subframe 0 and a subframe 5, the first physical channel carries first information, and the first information is system information or scheduling information of system information; and

a determining module, configured to determine the first information according to the received first physical channel.

In a first possible implementation manner, the multiple preset subframes further include either of a subframe 1 and a subframe 6.

In a second possible implementation manner, the multiple preset subframes further include a subframe 1 and a subframe 6.

With reference to any one of the fourth aspect to the second possible implementation manner of the fourth aspect, in a third possible implementation manner, the multiple preset subframes further include at least one of a subframe 3, a subframe 4, a subframe 7, a subframe 8, and a subframe 9.

With reference to the fourth aspect or the third possible implementation manner of the fourth aspect, in a fourth possible implementation manner, the multiple preset subframes further include the subframe 3, the subframe 4, the subframe 7, the subframe 8, and the subframe 9.

In a fifth possible implementation manner, the multiple preset subframes are all downlink subframes in a radio frame that is determined by a pre-stipulated uplink-downlink configuration; or

the multiple preset subframes further include all special subframes in a radio frame that is determined by a pre-stipulated uplink-downlink configuration; or

the multiple preset subframes further include all downlink subframes and special subframes, except a subframe 0 and a subframe 5, in a radio frame that is determined by a pre-stipulated uplink-downlink configuration; or

the multiple preset subframes are all subframes in the radio frame.

With reference to the fifth possible implementation manner of the fourth aspect, in a sixth possible implementation manner, that the multiple preset subframes further include all downlink subframes and special subframes, except a subframe 0 and a subframe 5, in a radio frame that is determined by a pre-stipulated uplink-downlink configuration includes:

the multiple preset subframes further include all downlink subframes and special subframes, except a subframe 0 and a subframe 5, in a radio frame that is determined by a pre-stipulated uplink-downlink configuration 5.

With reference to any one of the fourth aspect to the sixth possible implementation manner of the fourth aspect, in a seventh possible implementation manner, a configuration of the special subframe is a pre-stipulated special subframe configuration.

With reference to the seventh possible implementation manner of the fourth aspect, in an eighth possible implementation manner, for a downlink normal cyclic prefix, the configuration of the special subframe is a pre-stipulated special subframe configuration 4, and for a downlink extended cyclic prefix, the configuration of the special subframe is a pre-stipulated special subframe configuration 3.

With reference to the seventh possible implementation manner of the fourth aspect or the eighth possible implementation manner of the fourth aspect, in a ninth possible implementation manner, the special subframe is the subframe 1 and/or the subframe 6.

With reference to any one of the fourth aspect to the ninth possible implementation manner of the fourth aspect, in a tenth possible implementation manner, the receiving module is further configured to receive a second physical channel, where an uplink-downlink configuration of a radio frame for transmitting the second physical channel is different from an uplink-downlink configuration of the radio frame for transmitting the first information, and/or, a special subframe configuration of a special subframe in the radio frame for transmitting the second physical channel is different from a special subframe configuration of a special subframe in the radio frame for transmitting the first information; and the second physical channel includes any one of a physical downlink control channel PDCCH, an enhanced physical downlink control channel ePDCCH, a physical control format indicator channel PCFICH, a physical hybrid automatic repeat request indicator channel PHICH, and a physical downlink shared channel PDSCH.

With reference to any one of the fourth aspect to the tenth possible implementation manner of the fourth aspect, in an eleventh possible implementation manner, the system information is at least one of a master information block MIB, a master information block of a new UE category, a master information block of a new UE type, a master information block of coverage-enhanced UE, a master information block of delay-tolerant UE, and a machine type communication master information block MTC MIB; and

the first physical channel is a physical broadcast channel PBCH carrying the system information, and/or an enhanced PBCH carrying the system information.

With reference to any one of the fourth aspect to the tenth possible implementation manner of the fourth aspect, in a twelfth possible implementation manner, the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and

the first physical channel is a physical downlink shared channel PDSCH carrying the system information, and/or an enhanced PDSCH carrying the system information.

With reference to any one of the fourth aspect to the twelfth possible implementation manner of the fourth aspect, in a thirteenth possible implementation manner, the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SIB; and

the first physical channel is a physical downlink control channel PDCCH carrying the scheduling information, and/or an enhanced PDCCH carrying the scheduling information.

According to a fifth aspect, an embodiment of the present invention provides a base station, including:

a processor, configured to map first information onto multiple preset subframes in a radio frame, where the multiple preset subframes include at least a subframe 0 and a subframe 5, and the first information is system information or scheduling information of system information; and

a transmitter, configured to send a first physical channel to user equipment UE, where the first physical channel carries the first information.

In a first possible implementation manner, the multiple preset subframes further include either of a subframe 1 and a subframe 6.

In a second possible implementation manner, the multiple preset subframes further include a subframe 1 and a subframe 6.

With reference to any one of the fifth aspect to the second possible implementation manner of the fifth aspect, in a third possible implementation manner, the multiple preset subframes further include at least one of a subframe 3, a subframe 4, a subframe 7, a subframe 8, and a subframe 9.

With reference to the fifth aspect or the third possible implementation manner of the fifth aspect, in a fourth possible implementation manner, the multiple subframes further include the subframe 3, the subframe 4, the subframe 7, the subframe 8, and the subframe 9.

In a fifth possible implementation manner, the multiple preset subframes are all downlink subframes in a radio frame that is determined by a pre-stipulated uplink-downlink configuration; or

the multiple preset subframes further include all special subframes in a radio frame that is determined by a pre-stipulated uplink-downlink configuration; or

the multiple preset subframes further include all downlink subframes and special subframes, except a subframe 0 and a subframe 5, in a radio frame that is determined by a pre-stipulated uplink-downlink configuration; or

the multiple preset subframes are all subframes in the radio frame.

With reference to the fifth possible implementation manner of the fifth aspect, in a sixth possible implementation manner, that the multiple preset subframes further include all downlink subframes and special subframes, except a subframe 0 and a subframe 5, in a radio frame that is determined by a pre-stipulated uplink-downlink configuration includes:

the multiple preset subframes further include all downlink subframes and special subframes, except a subframe 0 and a subframe 5, in a radio frame that is determined by a pre-stipulated uplink-downlink configuration 5.

With reference to any one of the fifth aspect to the sixth possible implementation manner of the fifth aspect, in a seventh possible implementation manner, a configuration of the special subframe is a pre-stipulated special subframe configuration.

With reference to the seventh possible implementation manner of the fifth aspect, in an eighth possible implementation manner, for a downlink normal cyclic prefix, the configuration of the special subframe is a pre-stipulated special subframe configuration 4, and for a downlink extended cyclic prefix, the configuration of the special subframe is a pre-stipulated special subframe configuration 3.

With reference to the seventh possible implementation manner of the fifth aspect or the eighth possible implementation manner of the fifth aspect, in a ninth possible implementation manner, the special subframe is the subframe 1 and/or the subframe 6.

With reference to any one of the fifth aspect to the ninth possible implementation manner of the fifth aspect, in a tenth possible implementation manner, the transmitter is further configured to send a second physical channel to the UE, where an uplink-downlink configuration of a radio frame for transmitting the second physical channel is different from an uplink-downlink configuration of the radio frame for transmitting the first information, and/or, a special subframe configuration of a special subframe in the radio frame for transmitting the second physical channel is different from a special subframe configuration of a special subframe in the radio frame for transmitting the first information; and the second physical channel includes any one of a physical downlink control channel PDCCH, an enhanced physical downlink control channel ePDCCH, a physical control format indicator channel PCFICH, a physical hybrid automatic repeat request indicator channel PHICH, and a physical downlink shared channel PDSCH.

With reference to any one of the fifth aspect to the tenth possible implementation manner of the fifth aspect, in an eleventh possible implementation manner, the system information is at least one of a master information block MIB, a master information block of a new UE category, a master information block of a new UE type, a master information block of coverage-enhanced UE, a master information block of delay-tolerant UE, and a machine type communication master information block MTC MIB; and

the first physical channel is a physical broadcast channel PBCH carrying the system information, and/or an enhanced PBCH carrying the system information.

With reference to any one of the fifth aspect to the tenth possible implementation manner of the fifth aspect, in a twelfth possible implementation manner, the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and

the first physical channel is a physical downlink shared channel PDSCH carrying the system information, and/or an enhanced PDSCH carrying the system information.

With reference to any one of the fifth aspect to the twelfth possible implementation manner of the fifth aspect, in a thirteenth possible implementation manner, the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SIB; and

the first physical channel is a physical downlink control channel PDCCH carrying the scheduling information, and/or an enhanced PDCCH carrying the scheduling information.

According to a sixth aspect, an embodiment of the present invention provides user equipment, including:

a receiver, configured to receive a first physical channel in multiple preset subframes in a radio frame, where the multiple preset subframes include at least a subframe 0 and a subframe 5, the first physical channel carries first information, and the first information is system information or scheduling information of system information; and

a processor, configured to determine the first information according to the received first physical channel.

In a first possible implementation manner, the multiple preset subframes further include either of a subframe 1 and a subframe 6.

In a second possible implementation manner, the multiple preset subframes further include a subframe 1 and a subframe 6.

With reference to any one of the sixth aspect to the second possible implementation manner of the sixth aspect, in a third possible implementation manner, the multiple preset subframes further include at least one of a subframe 3, a subframe 4, a subframe 7, a subframe 8, and a subframe 9.

With reference to the sixth aspect or the third possible implementation manner of the sixth aspect, in a fourth possible implementation manner, the multiple preset subframes further include the subframe 3, the subframe 4, the subframe 7, the subframe 8, and the subframe 9.

In a fifth possible implementation manner, the multiple preset subframes are all downlink subframes in a radio frame that is determined by a pre-stipulated uplink-downlink configuration; or

the multiple preset subframes further include all special subframes in a radio frame that is determined by a pre-stipulated uplink-downlink configuration; or

the multiple preset subframes further include all downlink subframes and special subframes, except a subframe 0 and a subframe 5, in a radio frame that is determined by a pre-stipulated uplink-downlink configuration; or

the multiple preset subframes are all subframes in the radio frame.

With reference to the fifth possible implementation manner of the sixth aspect, in a sixth possible implementation manner, that the multiple preset subframes further include all downlink subframes and special subframes, except a subframe 0 and a subframe 5, in a radio frame that is determined by a pre-stipulated uplink-downlink configuration includes:

the multiple preset subframes further include all downlink subframes and special subframes, except a subframe 0 and a subframe 5, in a radio frame that is determined by a pre-stipulated uplink-downlink configuration 5.

With reference to any one of the sixth aspect to the sixth possible implementation manner of the sixth aspect, in a seventh possible implementation manner, a configuration of the special subframe is a pre-stipulated special subframe configuration.

With reference to the seventh possible implementation manner of the sixth aspect, in an eighth possible implementation manner, for a downlink normal cyclic prefix, the configuration of the special subframe is a pre-stipulated special subframe configuration 4, and for a downlink extended cyclic prefix, the configuration of the special subframe is a pre-stipulated special subframe configuration 3.

With reference to the seventh possible implementation manner of the sixth aspect or the eighth possible implementation manner of the sixth aspect, in a ninth possible implementation manner, the special subframe is the subframe 1 and/or the subframe 6.

With reference to any one of the sixth aspect to the ninth possible implementation manner of the sixth aspect, in a tenth possible implementation manner, the receiver is further configured to receive a second physical channel, where an uplink-downlink configuration of a radio frame for transmitting the second physical channel is different from an uplink-downlink configuration of the radio frame for transmitting the first information, and/or, a special subframe configuration of a special subframe in the radio frame for transmitting the second physical channel is different from a special subframe configuration of a special subframe in the radio frame for transmitting the first information; and the second physical channel includes any one of a physical downlink control channel PDCCH, an enhanced physical downlink control channel ePDCCH, a physical control format indicator channel PCFICH, a physical hybrid automatic repeat request indicator channel PHICH, and a physical downlink shared channel PDSCH.

With reference to any one of the sixth aspect to the tenth possible implementation manner of the sixth aspect, in an eleventh possible implementation manner, the system information is at least one of a master information block MIB, a master information block of a new UE category, a master information block of a new UE type, a master information block of coverage-enhanced UE, a master information block of delay-tolerant UE, and a machine type communication master information block MTC MIB; and

the first physical channel is a physical broadcast channel PBCH carrying the system information, and/or an enhanced PBCH carrying the system information.

With reference to any one of the sixth aspect to the tenth possible implementation manner of the sixth aspect, in a twelfth possible implementation manner, the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information new MTC SI; and

the first physical channel is a physical downlink shared channel PDSCH carrying the system information, and/or an enhanced PDSCH carrying the system information.

With reference to any one of the sixth aspect to the twelfth possible implementation manner of the sixth aspect, in a thirteenth possible implementation manner, the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SIB; and

the first physical channel is a physical downlink control channel PDCCH carrying the scheduling information, and/or an enhanced PDCCH carrying the scheduling information.

According to a seventh aspect, an embodiment of the present invention provides a communications system, including: the information transmission apparatus in a TDD system described in the third aspect and the information determining apparatus in a TDD system described in the fourth aspect.

According to an eighth aspect, an embodiment of the present invention provides a communications system, including: the base station described in the fifth aspect and the user equipment described in the sixth aspect.

The embodiments of the present invention provide the information transmission method, the information determining method, and apparatuses in a TDD system, and the system. In the method, first information is mapped onto multiple preset subframes in a radio frame, where the multiple preset subframes include at least a subframe 0 and a subframe 5, and the first information is system information or scheduling information of system information; then a first physical channel is sent to user equipment UE, where the first physical channel carries the first information, so that the UE can detect the first physical channel in multiple preset subframes, and determine the first information, thereby decreasing detection complexity and power consumption of the UE.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a flowchart of an information transmission method in a TDD system according to an embodiment of the present invention;

FIG. 2 is a flowchart of an information determining method in a TDD system according to another embodiment of the present invention;

FIG. 3A is a schematic diagram of multiple preset subframes in a radio frame according to an embodiment of the present invention;

FIG. 3B is a schematic diagram of multiple preset subframes in a radio frame according to another embodiment of the present invention;

FIG. 4 is a schematic diagram of mapping of an enhanced PBCH in a TDD system according to an embodiment of the present invention;

FIG. 5 is a schematic structural diagram of an information transmission apparatus in a TDD system according to an embodiment of the present invention;

FIG. 6 is a schematic structural diagram of an information determining apparatus in a TDD system according to an embodiment of the present invention;

FIG. 7 is a schematic structural diagram of a base station according to an embodiment of the present invention; and

FIG. 8 is a schematic structural diagram of user equipment according to an embodiment of the present invention.

### DETAILED DESCRIPTION OF ILLUSTRATIVE EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

FIG. 1 is a flowchart of an information transmission method in a TDD system according to an embodiment of the present invention. As shown in FIG. 1, the method in this embodiment includes:

Step 101: Map first information onto multiple preset subframes in a radio frame, where the multiple preset subframes include at least a subframe 0 and a subframe 5.

In this embodiment, a base station may map the first information onto the multiple preset subframes in the radio frame, where the multiple preset subframes include at least the subframe 0 and the subframe 5, and the first information may be system information or scheduling information of system information.

For example, the multiple preset subframes may include the subframe 0 and the subframe 5; or, in addition to the subframe 0 and the subframe 5, the multiple preset subframes further include at least one of a subframe 1 and a subframe 6; or in addition to the subframe 0 and the subframe 5, the multiple preset subframes further include at least one of a subframe 3, a subframe 4, a subframe 7, a subframe 8, and a subframe 9.

Optionally, the multiple preset subframes are all downlink subframes in a radio frame that is determined by a pre-stipulated uplink-downlink configuration; or, in addition to the subframe 0 and the subframe 5, the multiple preset subframes further include all special subframes in a radio frame that is determined by a pre-stipulated uplink-downlink configuration; or, in addition to the subframe 0 and the subframe 5, the multiple preset subframes further include all downlink subframes and special subframes, except a subframe 0 and a subframe 5, in a radio frame that is determined by a pre-stipulated uplink-downlink configuration; or, the multiple preset subframes are all subframes in the radio frame.

It should be noted that, resources of an LTE system are divided into multiple radio frames in a time domain, where one radio frame includes 10 subframes that are arranged in the radio frame in a sequence of a subframe 0, a subframe 1 to a subframe 9. A length of each subframe is 1 millisecond, each subframe includes two timeslots, and a length of each timeslot is 0.5 milliseconds. When a cyclic prefix of a subframe is a normal cyclic prefix (CP for short), each timeslot includes seven orthogonal frequency division multiplexing symbols; or when a cyclic prefix of a subframe is an extended CP, each timeslot includes six orthogonal frequency division multiplexing symbols.

Step 102: Send a first physical channel to user equipment UE, where the first physical channel carries the first information.

In this embodiment, the base station sends the first physical channel to the UE, where the first physical channel carries the first information, where that the first information may be system information or scheduling information of system information may be specifically:

the system information may be at least one of a master information block MIB, a master information block of a new UE category, a master information block of coverage-enhanced UE, a master information block of delay-tolerant UE, and a machine type communication master information block MTC MIB; correspondingly, the first physical channel is a physical broadcast channel PBCH carrying the system information, and/or an enhanced PBCH carrying the system information.

For example, the system information is a master information block MIB, and correspondingly, the first physical channel is a physical broadcast channel PBCH carrying the MIB, and/or an enhanced PBCH carrying the MIB; or

the system information is a machine type communication master information block MTC MIB, and correspondingly, the first physical channel is a physical broadcast channel PBCH carrying the MTC MIB, and/or an enhanced PBCH carrying the MTC MIB.

Optionally, the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and correspondingly, the first physical channel is a physical downlink shared channel PDSCH carrying the system information, and/or an enhanced PDSCH carrying the system information.

For example, the system information is a system information block type 1 SIB1, and correspondingly, the first physical channel is a physical downlink shared channel PDSCH carrying the SIB1, and/or an enhanced PDSCH carrying the SIB1; or

the system information is a SIB2, and correspondingly, the first physical channel is a physical downlink shared channel PDSCH carrying the SIB2, and/or an enhanced PDSCH carrying the SIB2; or

the system information is SI, and correspondingly, the first physical channel is a physical downlink shared channel PDSCH carrying the SI, and/or an enhanced PDSCH carrying the SI; or

the system information is an MTC SIB1, and correspondingly, the first physical channel is a physical downlink shared channel PDSCH carrying the MTC SIB1, and/or an enhanced PDSCH carrying the MTC SIB1; or

the system information is an MTC SIB2, and correspondingly, the first physical channel is a physical downlink shared channel PDSCH carrying the MTC SIB2, and/or an enhanced PDSCH carrying the MTC SIB2; or

the system information is MTC SI, and correspondingly, the first physical channel is a physical downlink shared channel PDSCH carrying the MTC SI, and/or an enhanced PDSCH carrying the MTC SI; or

the system information is new MTC SI, and correspondingly, the first physical channel is a physical downlink shared channel PDSCH carrying the new MTC SI, and/or an enhanced PDSCH carrying the new MTC SI.

Further, based on the foregoing embodiment, the scheduling information may be at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SIB; and correspondingly, the first physical channel is a physical downlink control channel PDCCH carrying the foregoing DCI, and/or an enhanced PDCCH carrying the DCI.

For example, the scheduling information is DCI for scheduling a SIB1, and correspondingly, the first physical channel is a PDCCH carrying the DCI for scheduling a SIB1, and/or an enhanced PDCCH carrying the DCI for scheduling a SIB1; or

the scheduling information is DCI for scheduling a SIB2, and correspondingly, the first physical channel is a PDCCH carrying the DCI for scheduling a SIB2, and/or an enhanced PDCCH carrying the DCI for scheduling a SIB2; or

the scheduling information is DCI for scheduling SI, and correspondingly, the first physical channel is a PDCCH carrying the DCI for scheduling SI, and/or an enhanced PDCCH carrying the DCI for scheduling SI; or

the scheduling information is DCI for scheduling an MTC SIB1, and correspondingly, the first physical channel is a PDCCH carrying the DCI for scheduling an MTC SIB1, and/or an enhanced PDCCH carrying the DCI for scheduling an MTC SIB1; or

the scheduling information is DCI for scheduling an MTC SIB2, and correspondingly, the first physical channel is a PDCCH carrying the DCI for scheduling an MTC SIB2, and/or an enhanced PDCCH carrying the DCI for scheduling an MTC SIB2; or

the scheduling information is DCI for scheduling MTC SI, and correspondingly, the first physical channel is a PDCCH carrying the DCI for scheduling MTC SI, and/or an enhanced PDCCH carrying the DCI for scheduling MTC SI; or

the scheduling information is the DCI for scheduling a new MTC SIB, and correspondingly, the first physical channel is a PDCCH carrying the DCI for scheduling a new MTC SIB, and/or an enhanced PDCCH carrying the DCI for scheduling a new MTC SIB.

In the information transmission method in a TDD system provided in this embodiment of the present invention, first information is mapped onto multiple preset subframes in a radio frame, where the multiple preset subframes include at least a subframe 0 and a subframe 5, and the first information is system information or scheduling information of system information; then a first physical channel is sent to user equipment UE, where the first physical channel carries the first information, so that the UE can detect the first physical channel in multiple preset subframes, and determine the first information, thereby decreasing detection complexity and power consumption of the UE.

Further, based on the foregoing embodiment, after step 102, the method may further include:

sending a second physical channel to the UE, where an uplink-downlink configuration of a radio frame for transmitting the second physical channel is different from an uplink-downlink configuration of the radio frame for transmitting the first information, and/or, a special subframe configuration of a special subframe in the radio frame for transmitting the second physical channel is different from a special subframe configuration of a special subframe in the radio frame for transmitting the first information; and the second physical channel includes any one of a physical downlink control channel PDCCH, an enhanced physical downlink control channel ePDCCH, a physical control format indicator channel PCFICH, a physical hybrid automatic repeat request indicator channel PHICH, and a physical downlink shared channel PDSCH.

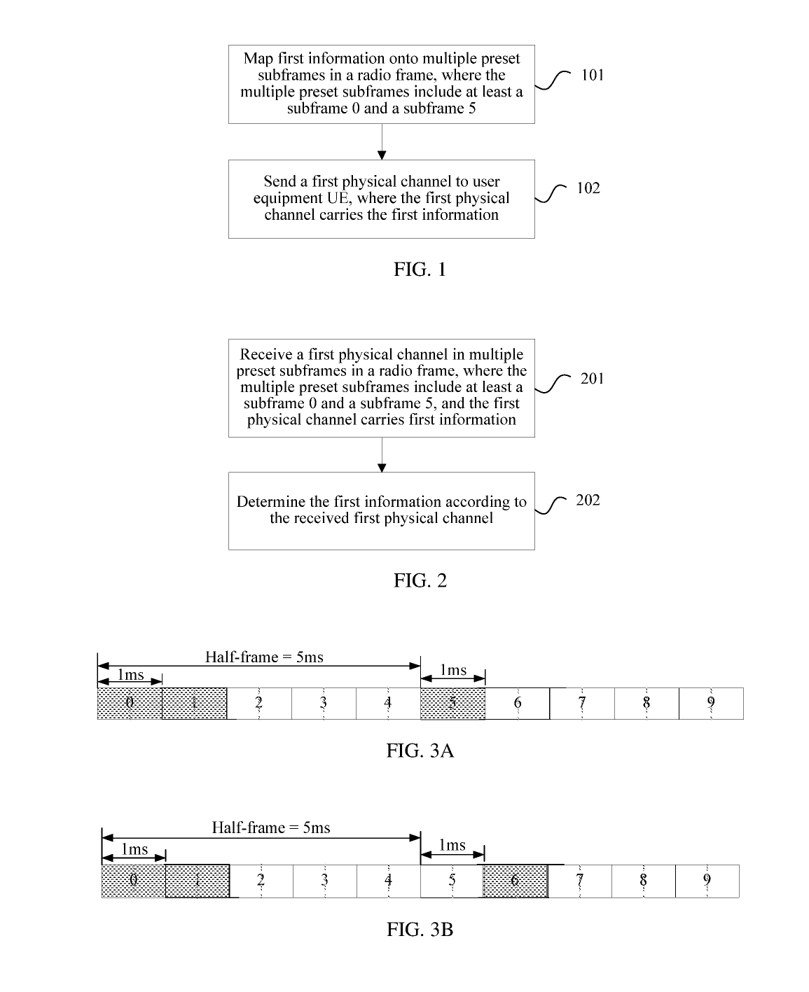

FIG. 2 is a flowchart of an information determining method in a TDD system according to another embodiment of the present invention. As shown in FIG. 2, the method in this embodiment includes:

Step 201: Receive a first physical channel in multiple preset subframes in a radio frame, where the multiple preset subframes include at least a subframe 0 and a subframe 5, and the first physical channel carries first information.

Specifically, UE may receive the first physical channel in the multiple preset subframes in the radio frame, where the multiple preset subframes include at least the subframe 0 and the subframe 5.

For example, the multiple preset subframes may include the subframe 0 and the subframe 5; or, in addition to the subframe 0 and the subframe 5, the multiple preset subframes further include either of a subframe 1 and a subframe 6; or in addition to the subframe 0 and the subframe 5, the multiple preset subframes further include at least one of a subframe 3, a subframe 4, a subframe 7, a subframe 8, and a subframe 9.

Optionally, the multiple preset subframes are all downlink subframes in a radio frame that is determined by a pre-stipulated uplink-downlink configuration; or the multiple preset subframes further include all special subframes in a radio frame that is determined by a pre-stipulated uplink-downlink configuration; or the multiple preset subframes further include all downlink subframes and special subframes, except a subframe 0 and a subframe 5, in a radio frame that is determined by a pre-stipulated uplink-downlink configuration; or the multiple preset subframes are all subframes in the radio frame.

In this embodiment, the first information is system information or scheduling information of system information.

Specifically, the system information may be at least one of a master information block MIB and a machine type communication master information block MTC MIB; and correspondingly, the first physical channel is a physical broadcast channel PBCH carrying the system information, and/or an enhanced PBCH carrying the system information.

For example, the system information is a master information block MIB, and correspondingly, the first physical channel is a physical broadcast channel PBCH carrying the MIB, and/or an enhanced PBCH carrying the MIB; or

the system information is a machine type communication master information block MTC MIB, and correspondingly, the first physical channel is a physical broadcast channel PBCH carrying the MTC MIB, and/or an enhanced PBCH carrying the MTC MIB.

Optionally, the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information new MTC SI; and correspondingly, the first physical channel is a physical downlink shared channel PDSCH carrying the system information, and/or an enhanced PDSCH carrying the system information.

For example, the system information is a system information block type 1 SIB1, and correspondingly, the first physical channel is a physical downlink shared channel PDSCH carrying the SIB1, and/or an enhanced PDSCH carrying the SIB1; or

the system information is a SIB2, and correspondingly, the first physical channel is a physical downlink shared channel PDSCH carrying the SIB2, and/or an enhanced PDSCH carrying the SIB2; or

the system information is SI, and correspondingly, the first physical channel is a physical downlink shared channel PDSCH carrying the SI, and/or an enhanced PDSCH carrying the SI; or

the system information is an MTC SIB1, and correspondingly, the first physical channel is a physical downlink shared channel PDSCH carrying the MTC SIB1, and/or an enhanced PDSCH carrying the MTC SIB1; or

the system information is an MTC SIB2, and correspondingly, the first physical channel is a physical downlink shared channel PDSCH carrying the MTC SIB2, and/or an enhanced PDSCH carrying the MTC SIB2; or

the system information is MTC SI, and correspondingly, the first physical channel is a physical downlink shared channel PDSCH carrying the MTC SI, and/or an enhanced PDSCH carrying the MTC SI; or

the system information is new MTC SI, and correspondingly, the first physical channel is a physical downlink shared channel PDSCH carrying the new MTC SI, and/or an enhanced PDSCH carrying the new MTC SI.

Further, based on the foregoing embodiment, the scheduling information may be at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SIB; and correspondingly, the first physical channel is a physical downlink control channel PDCCH carrying the foregoing DCI, and/or an enhanced PDCCH carrying the DCI.

For example, the scheduling information is DCI for scheduling a SIB1, and correspondingly, the first physical channel is a PDCCH carrying the DCI for scheduling a SIB1, and/or an enhanced PDCCH carrying the DCI for scheduling a SIB1; or

the scheduling information is DCI for scheduling a SIB2, and correspondingly, the first physical channel is a PDCCH carrying the DCI for scheduling a SIB2, and/or an enhanced PDCCH carrying the DCI for scheduling a SIB2; or

the scheduling information is DCI for scheduling SI, and correspondingly, the first physical channel is a PDCCH carrying the DCI for scheduling SI, and/or an enhanced PDCCH carrying the DCI for scheduling SI; or

the scheduling information is DCI for scheduling an MTC SIB1, and correspondingly, the first physical channel is a PDCCH carrying the DCI for scheduling an MTC SIB1, and/or an enhanced PDCCH carrying the DCI for scheduling an MTC SIB1; or

the scheduling information is DCI for scheduling an MTC SIB2, and correspondingly, the first physical channel is a PDCCH carrying the DCI for scheduling an MTC SIB2, and/or an enhanced PDCCH carrying the DCI for scheduling an MTC SIB2; or

the scheduling information is DCI for scheduling MTC SI, and correspondingly, the first physical channel is a PDCCH carrying the DCI for scheduling MTC SI, and/or an enhanced PDCCH carrying the DCI for scheduling MTC SI; or

the scheduling information is DCI for scheduling a new MTC SIB, and correspondingly, the first physical channel is a PDCCH carrying the DCI for scheduling a new MTC SIB, and/or an enhanced PDCCH carrying the DCI for scheduling a new MTC SIB.

Step 202: Determine first information according to the received first physical channel.

In this embodiment, the UE receives the first physical channel in the multiple preset subframes in the radio frame, and determines the first information according to the received first physical channel.

It should be noted that, resources of an LTE system are divided into multiple radio frames in a time domain, where one radio frame includes 10 subframes that are arranged in the radio frame in a sequence of a subframe 0, a subframe 1 to a subframe 9.

In the information determining method in a TDD system provided in this embodiment of the present invention, a first physical channel is received in multiple preset subframes in a radio frame, where the multiple preset subframes include at least a subframe 0 and a subframe 5, the first physical channel carries first information, and the first information is system information or scheduling information of system information; then, the first information is determined according to the received first physical channel, so that the UE detects the first physical channel in the determined multiple subframes, so as to decrease detection complexity and power consumption of the UE.

Further, based on the foregoing embodiment, after step 202, the method further includes:

receiving a second physical channel, where an uplink-downlink configuration of a radio frame for transmitting the second physical channel is different from an uplink-downlink configuration of the radio frame for transmitting the first information, and/or, a special subframe configuration of a special subframe in the radio frame for transmitting the second physical channel is different from a special subframe configuration of a special subframe in the radio frame for transmitting the first information; and the second physical channel includes any one of a physical downlink control channel PDCCH, an enhanced physical downlink control channel ePDCCH, a physical control format indicator channel PCFICH, a physical hybrid automatic repeat request indicator channel PHICH, and a physical downlink shared channel PDSCH.

In the LTE TDD system, one radio frame may include 10 subframes, for example, a subframe 0 to a subframe 9, and the radio frame is formed by two half-frames with a length of 5 milliseconds, and each half-frame has 5 subframes with a length of 1 millisecond. In addition to the subframe 0 and the subframe 5, the multiple preset subframes may further include another subframe in the radio frame.

For example, the multiple preset subframes may further include either of the subframe 1 and the subframe 6.

FIG. 3A is a schematic diagram of multiple preset subframes in a radio frame according to an embodiment of the present invention. FIG. 3B is a schematic diagram of multiple preset subframes in a radio frame according to another embodiment of the present invention. As shown in FIG. 3A, first information may be mapped onto a subframe 0, a subframe 1, and a subframe 5 in a radio frame, or as shown in FIG. 3B, first information may be mapped onto a subframe 0, a subframe 5, and a subframe 6 in a radio frame.

Optionally, based on the foregoing embodiment, multiple subframes may further include a subframe 1 and a subframe 6. That is, the first information may be mapped onto the subframe 0, the subframe 1, the subframe 5, and the subframe 6 in the radio frame.

Further, based on the foregoing embodiment, the multiple preset subframes may further include at least one of a subframe 3, a subframe 4, a subframe 7, a subframe 8, and a subframe 9.

For example, in addition to the subframe 0, the subframe 1, the subframe 5, and the subframe 6, the multiple preset subframes may further include any one of the subframe 3, the subframe 4, the subframe 7, the subframe 8, and the subframe 9; or the multiple preset subframes may further include any two of the subframe 3, the subframe 4, the subframe 7, the subframe 8, and the subframe 9; or the multiple preset subframes may further include any three of all the subframe 3, the subframe 4, the subframe 7, the subframe 8, and the subframe 9; or the multiple preset subframes may further include all the subframe 3, the subframe 4, the subframe 7, the subframe 8, and the subframe 9.

Another implementation manner of this embodiment may further include any one of the following:

In a first implementation manner, the multiple preset subframes are all downlink subframes in a radio frame that is determined by a pre-stipulated uplink-downlink configuration.

For example, the multiple preset subframes may include all downlink subframes in a radio frame that is determined by a pre-stipulated uplink-downlink configuration 5. As shown in Table 1, the multiple subframes may be a subframe 0, a subframe 3, a subframe 4, a subframe 5, a subframe 6, a subframe 7, a subframe 8, and a subframe 9.

Specifically, for example, a MIB and/or an MTC MIB are mapped onto the subframe 0, the subframe 3, the subframe 4, the subframe 5, the subframe 6, the subframe 7, the subframe 8, and the subframe 9.

TABLE 1

| | Period of a | | | | | | | | | | |
|---|---|---|---|---|---|---|---|---|---|---|---|
| Uplink- | switchover | | | | | | | | | | |
| downlink | point from | | | | | | | | | | |
| config- | downlink | Subframe number | | | | | | | | | |
| uration | to uplink | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

“D” in Table 1 represents that this subframe is used for downlink transmission, “U” represents that this subframe is used for uplink transmission, and “S” represents that this subframe is a special subframe.

In a second implementation manner, the multiple preset subframes further include all special subframes in a radio frame that is determined by a pre-stipulated uplink-downlink configuration.

For example, as shown in Table 1, the multiple preset subframes further include all special subframes in a radio frame that is determined by a pre-stipulated uplink-downlink configuration 5, that is, the multiple preset subframes further include a subframe 1.

In a third implementation manner, the multiple preset subframes further include all downlink subframes and special subframes, except a subframe 0 and a subframe 5, in a radio frame that is determined by a pre-stipulated uplink-downlink configuration.

For example, the multiple preset subframes further include all downlink subframes and special subframes, except a subframe 0 and a subframe 5, in a radio frame that is determined by a pre-stipulated uplink-downlink configuration 5. As shown in Table 1, in addition to the subframe 0 and the subframe 5, the multiple preset subframes further include a subframe 1, a subframe 3, a subframe 4, a subframe 6, a subframe 7, a subframe 8, and a subframe 9.

Further, in this embodiment, for a downlink normal cyclic prefix, a special subframe configuration is a pre-stipulated special subframe configuration 4 (as shown in Table 2), and for a downlink extended cyclic prefix, a special subframe configuration is a pre-stipulated special subframe configuration 3 (as shown in Table 2).

Specifically, a MIB and/or an MTC MIB are mapped onto the subframe 0, the subframe 1, the subframe 3, the subframe 4, the subframe 5, the subframe 6, the subframe 7, the subframe 8, and the subframe 9.

In a fourth implementation manner, the multiple preset subframes are all subframes in the radio frame, that is, all 10 subframes in the radio frame.

It should be noted that, in the foregoing embodiment, if the multiple preset subframes in the radio frame include a special subframe, a special subframe configuration of the special subframe is a pre-stipulated special subframe configuration.

TABLE 2

| | Downlink normal CP | | | Downlink extended CP | | |
|---|---|---|---|---|---|---|
| Special | | UpPTS | | | UpPTS | |
| subframe | | Uplink | Uplink | | Uplink | Uplink |
| configuration | DwPTS | normal CP | extended CP | DwPTS | normal CP | extended CP |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

The special subframe configuration of the special subframe is a pre-stipulated special subframe configuration from the special subframe configuration 0 to the special subframe configuration 8 shown in Table 2. For example, for the downlink normal cyclic prefix, the configuration of the special subframe is the pre-stipulated special subframe configuration 4, and for the downlink extended cyclic prefix, the configuration of the special subframe is the pre-stipulated special subframe configuration 3. Further, the special subframe may be the subframe 1 and/or the subframe 6.

Specifically, one special subframe is formed by three fields, namely, UpPTS, GP, and DwPTS. Special subframe configurations corresponding to time lengths of the UpPTS and the DwPTS are shown in Table 2, where a total time length of the UpPTS, the GP, and the DwPTS is 1 millisecond.

For example, for the downlink normal CP, if the multiple preset subframes in the radio frame include a special subframe 1, a special subframe configuration of the special subframe 1 is a pre-stipulated special subframe configuration 4. Therefore, a structure of the special subframe 1 is:

DwPTS is 26336·Tₛ, and in the UpPTS, the uplink normal CP is 2192·Tₛ, and the uplink extended CP is 2560·Tₛ.

In the LTE TDD system, system information and/or scheduling information of system information is transmitted by using multiple preset subframes, thereby avoiding a large amount of power consumption of UE that is caused by the fact that the UE performs blind detection on the system information and/or the scheduling information of the system information.

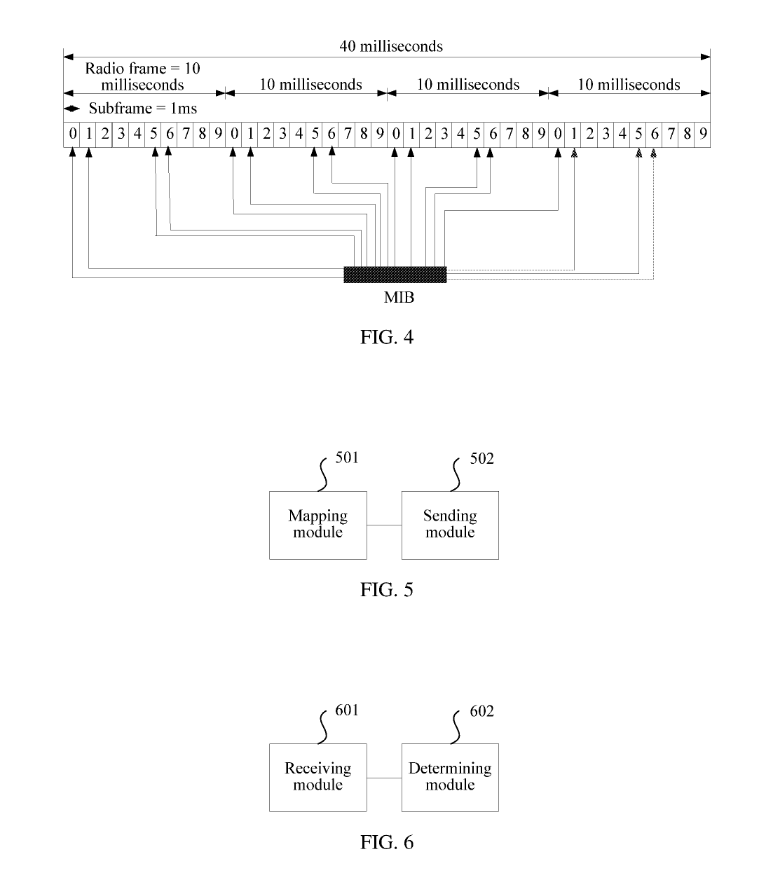

FIG. 4 is a schematic diagram of mapping of an enhanced PBCH in a TDD system according to an embodiment of the present invention. As shown in FIG. 4, in the LTE TDD system, an enhanced PBCH is mapped onto four consecutive radio frames, and in each radio frame of the four radio frames, a MIB carried in the enhanced PBCH is mapped onto a preset subframe 0, subframe 1, subframe 5, and subframe 6. That is, the enhanced PBCH not only includes an existing PBCH, but also includes repeated sending of a MIB. Further, special subframe configurations in the subframe 1 and the subframe 6 are pre-stipulated, so that the enhanced PBCH can map a MIB in a downlink orthogonal frequency division multiplexing symbol that is determined by the pre-stipulated special subframe configuration.

For UE, even if the UE does not know an uplink-downlink configuration of the TDD system, the UE can receive the enhanced PBCH in the preset subframe 0, subframe 1, subframe 5, and subframe 6 in each radio frame of the four radio frames. Further, the UE receives the enhanced PBCH according to the pre-stipulated special subframe configurations of the subframe 1 and the subframe 6, so as to determine the MIB carried in the enhanced PBCH.

FIG. 5 is a schematic structural diagram of an information transmission apparatus in a TDD system according to an embodiment of the present invention. As shown in FIG. 5, the information transmission apparatus in a TDD system includes a mapping module 501 and a sending module 502, where

the mapping module 501 is configured to map first information onto multiple preset subframes in a radio frame, where the multiple preset subframes include at least a subframe 0 and a subframe 5, and the first information is system information or scheduling information of system information; and

the sending module 502 is configured to send a first physical channel to user equipment UE, where the first physical channel carries the first information.

In the information transmission apparatus in a TDD system provided in this embodiment of the present invention, first information is mapped onto multiple preset subframes in a radio frame, where the multiple preset subframes include at least a subframe 0 and a subframe 5, and the first information is system information or scheduling information of system information; then a first physical channel is sent to user equipment UE, where the first physical channel carries the first information, so that the UE can detect the first physical channel in multiple preset subframes in a radio frame, and determine the first information according to the received first physical channel, thereby decreasing detection complexity and power consumption of the UE.

Based on the foregoing embodiment, the multiple preset subframes further include either of a subframe 1 and a subframe 6.

Optionally, the multiple preset subframes further include the subframe 1 and the subframe 6.

Further, based on the foregoing embodiment, the multiple preset subframes further include at least one of a subframe 3, a subframe 4, a subframe 7, a subframe 8, and a subframe 9.

Optionally, the multiple subframes further include the subframe 3, the subframe 4, the subframe 7, the subframe 8, and the subframe 9.

Based on the foregoing embodiment, the multiple preset subframes are all downlink subframes in a radio frame that is determined by a pre-stipulated uplink-downlink configuration; or

the multiple preset subframes further include all special subframes in a radio frame that is determined by a pre-stipulated uplink-downlink configuration; or

the multiple preset subframes further include all downlink subframes and special subframes, except a subframe 0 and a subframe 5, in a radio frame that is determined by a pre-stipulated uplink-downlink configuration; or

the multiple preset subframes are all subframes in the radio frame.

Further, based on the foregoing embodiment, that the multiple preset subframes further include all downlink subframes and special subframes, except a subframe 0 and a subframe 5, in a radio frame that is determined by a pre-stipulated uplink-downlink configuration includes:

the multiple preset subframes further include all downlink subframes and special subframes, except a subframe 0 and a subframe 5, in a radio frame that is determined by a pre-stipulated uplink-downlink configuration 5, that is, in addition to the subframe 0 and the subframe 5, the multiple preset subframes further include a subframe 1, a subframe 3, a subframe 4, a subframe 6, a subframe 7, a subframe 8, and a subframe 9.

Based on the foregoing embodiment, a configuration of the special subframe is a pre-stipulated special subframe configuration.

Further, based on the foregoing embodiment, for a downlink normal cyclic prefix, the configuration of the special subframe is a pre-stipulated special subframe configuration 4, and for a downlink extended cyclic prefix, the configuration of the special subframe is a pre-stipulated special subframe configuration 3.

Further, based on the foregoing embodiment, the special subframe is the subframe 1 and/or the subframe 6.

Based on the foregoing embodiment, the sending module 502 is further configured to send a second physical channel to the UE, where an uplink-downlink configuration of a radio frame for transmitting the second physical channel is different from an uplink-downlink configuration of the radio frame for transmitting the first information, and/or, a special subframe configuration of a special subframe in the radio frame for transmitting the second physical channel is different from a special subframe configuration of a special subframe in the radio frame for transmitting the first information; and the second physical channel includes any one of a physical downlink control channel PDCCH, an enhanced physical downlink control channel ePDCCH, a physical control format indicator channel PCFICH, a physical hybrid automatic repeat request indicator channel PHICH, and a physical downlink shared channel PDSCH.

Based on the foregoing embodiment, the system information is at least one of a master information block MIB, a master information block of a new UE category, a master information block of a new UE type, a master information block of coverage-enhanced UE, a master information block of delay-tolerant UE, and a machine type communication master information block MTC MIB; and

the first physical channel is a physical broadcast channel PBCH carrying the system information, and/or an enhanced PBCH carrying the system information.

Based on the foregoing embodiment, the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and

the first physical channel is a physical downlink shared channel PDSCH carrying the system information, and/or an enhanced PDSCH carrying the system information.

Based on the foregoing embodiment, the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SIB; and

the first physical channel is a physical downlink control channel PDCCH carrying the DCI, and/or an enhanced PDCCH carrying the DCI.

FIG. 6 is a schematic structural diagram of an information determining apparatus in a TDD system according to an embodiment of the present invention. As shown in FIG. 6, the information determining apparatus in the TDD system includes a receiving module 601 and a determining module 602, where

the receiving module 601 is configured to receive a first physical channel in multiple preset subframes in a radio frame, where the multiple preset subframes include at least a subframe 0 and a subframe 5, the first physical channel carries first information, and the first information is system information or scheduling information of system information; and

the determining module 602 is configured to determine the first information according to the received first physical channel.

In the information determining apparatus in a TDD system provided in this embodiment of the present invention, a first physical channel is received in multiple preset subframes in a radio frame, where the multiple preset subframes include at least a subframe 0 and a subframe 5, the first physical channel carries first information, and the first information is system information or scheduling information of system information; then, the first information is determined according to the received first physical channel, so as to decrease detection complexity and power consumption of the UE.

Based on the foregoing embodiment, the multiple preset subframes further include either of a subframe 1 and a subframe 6.

Optionally, based on the foregoing embodiment, the multiple preset subframes further include the subframe 1 and the subframe 6.

Based on the foregoing embodiment, the multiple preset subframes further include at least one of a subframe 3, a subframe 4, a subframe 7, a subframe 8, and a subframe 9.

Optionally, based on the foregoing embodiment, the multiple preset subframes further include the subframe 3, the subframe 4, the subframe 7, the subframe 8, and the subframe 9.

Further, based on the foregoing embodiment, the multiple preset subframes are all downlink subframes in a radio frame that is determined by a pre-stipulated uplink-downlink configuration; or

the multiple preset subframes further include all special subframes in a radio frame that is determined by a pre-stipulated uplink-downlink configuration; or

the multiple preset subframes further include all downlink subframes and special subframes, except a subframe 0 and a subframe 5, in a radio frame that is determined by a pre-stipulated uplink-downlink configuration; or

the multiple preset subframes are all subframes in the radio frame.

Based on the foregoing embodiment, that the multiple preset subframes further include all downlink subframes and special subframes, except a subframe 0 and a subframe 5, in a radio frame that is determined by a pre-stipulated uplink-downlink configuration includes:

the multiple preset subframes further include all downlink subframes and special subframes, except a subframe 0 and a subframe 5, in a radio frame that is determined by a pre-stipulated uplink-downlink configuration 5, that is, in addition to the subframe 0 and the subframe 5, the multiple preset subframes further include a subframe 1, a subframe 3, a subframe 4, a subframe 6, a subframe 7, a subframe 8, and a subframe 9.

Based on the foregoing embodiment, a configuration of the special subframe is a pre-stipulated special subframe configuration.

Further, based on the foregoing embodiment, for a downlink normal cyclic prefix, the configuration of the special subframe is a pre-stipulated special subframe configuration 4, and for a downlink extended cyclic prefix, the configuration of the special subframe is a pre-stipulated special subframe configuration 3.

Further, based on the foregoing embodiment, the special subframe is the subframe 1 and/or the subframe 6.

Optionally, based on the foregoing embodiment, the receiving module 601 is further configured to receive a second physical channel, where an uplink-downlink configuration of a radio frame for transmitting the second physical channel is different from an uplink-downlink configuration of the radio frame for transmitting the first information, and/or, a special subframe configuration of a special subframe in the radio frame for transmitting the second physical channel is different from a special subframe configuration of a special subframe in the radio frame for transmitting the first information; and the second physical channel includes any one of a physical downlink control channel PDCCH, an enhanced physical downlink control channel ePDCCH, a physical control format indicator channel PCFICH, a physical hybrid automatic repeat request indicator channel PHICH, and a physical downlink shared channel PDSCH.

Further, based on the foregoing embodiment, the system information is at least one of a master information block MIB, a master information block of a new UE category, a master information block of a new UE type, a master information block of coverage-enhanced UE, a master information block of delay-tolerant UE, and a machine type communication master information block MTC MIB; and

the first physical channel is a physical broadcast channel PBCH carrying the system information, and/or an enhanced PBCH carrying the system information.

Based on the foregoing embodiment, the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and

the first physical channel is a physical downlink shared channel PDSCH carrying the system information, and/or an enhanced PDSCH carrying the system information.

Based on the foregoing embodiment, the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SIB; and

the first physical channel is a physical downlink control channel PDCCH carrying the DCI, and/or an enhanced PDCCH carrying the DCI.

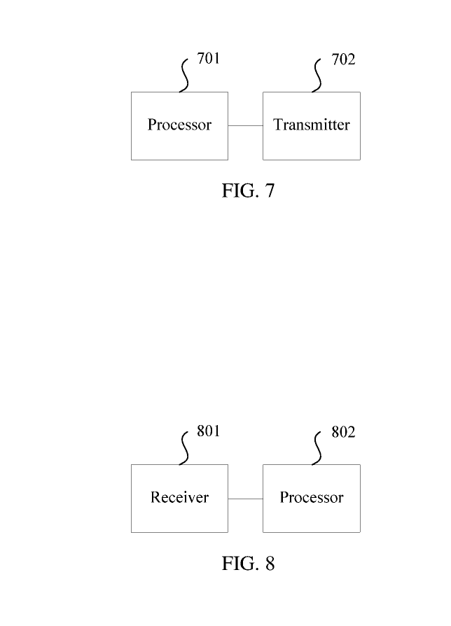

FIG. 7 is a schematic structural diagram of a base station according to an embodiment of the present invention. As shown in FIG. 7, the base station includes a processor 701 and a transmitter 702, where

the processor 701 is configured to map first information onto multiple preset subframes in a radio frame, where the multiple preset subframes include at least a subframe 0 and a subframe 5, and the first information is system information or scheduling information of system information; and

the transmitter 702 is configured to send a first physical channel to user equipment UE, where the first physical channel carries the first information.

In the base station provided in this embodiment of the present invention, first information is mapped onto multiple preset subframes in a radio frame, where the multiple preset subframes include at least a subframe 0 and a subframe 5, and the first information is system information or scheduling information of system information; then a first physical channel is sent to user equipment UE, where the first physical channel carries the first information, so that the UE receives the first physical channel in multiple preset subframes in a radio frame, and determines the first information according to the received first physical channel, thereby decreasing detection complexity and power consumption of the UE.

Based on the foregoing embodiment, the multiple preset subframes further include either of a subframe 1 and a subframe 6.

Optionally, based on the foregoing embodiment, the multiple preset subframes further include the subframe 1 and the subframe 6.

Based on the foregoing embodiment, the multiple preset subframes further include at least one of a subframe 3, a subframe 4, a subframe 7, a subframe 8, and a subframe 9.

Optionally, based on the foregoing embodiment, the multiple subframes further include the subframe 3, the subframe 4, the subframe 7, the subframe 8, and the subframe 9.

Based on the foregoing embodiment, the multiple preset subframes are all downlink subframes in a radio frame that is determined by a pre-stipulated uplink-downlink configuration; or

the multiple preset subframes further include all special subframes in a radio frame that is determined by a pre-stipulated uplink-downlink configuration; or

the multiple preset subframes further include all downlink subframes and special subframes, except a subframe 0 and a subframe 5, in a radio frame that is determined by a pre-stipulated uplink-downlink configuration; or

the multiple preset subframes are all subframes in the radio frame.

Further, based on the foregoing embodiment, that the multiple preset subframes further include all downlink subframes and special subframes, except a subframe 0 and a subframe 5, in a radio frame that is determined by a pre-stipulated uplink-downlink configuration includes:

the multiple preset subframes further include all downlink subframes and special subframes, except a subframe 0 and a subframe 5, in a radio frame that is determined by a pre-stipulated uplink-downlink configuration 5, that is, in addition to the subframe 0 and the subframe 5, the multiple preset subframes further include a subframe 1, a subframe 3, a subframe 4, a subframe 6, a subframe 7, a subframe 8, and a subframe 9.

Based on the foregoing embodiment, a configuration of the special subframe is a pre-stipulated special subframe configuration.

Further, based on the foregoing embodiment, for a downlink normal cyclic prefix, the configuration of the special subframe is a pre-stipulated special subframe configuration 4, and for a downlink extended cyclic prefix, the configuration of the special subframe is a pre-stipulated special subframe configuration 3.

Optionally, based on the foregoing embodiment, the special subframe is the subframe 1 and/or the subframe 6.

Further, based on the foregoing embodiment, the transmitter 702 is further configured to send a second physical channel to the UE, where an uplink-downlink configuration of a radio frame for transmitting the second physical channel is different from an uplink-downlink configuration of the radio frame for transmitting the first information, and/or, a special subframe configuration of a special subframe in the radio frame for transmitting the second physical channel is different from a special subframe configuration of a special subframe in the radio frame for transmitting the first information; and the second physical channel includes any one of a physical downlink control channel PDCCH, an enhanced physical downlink control channel ePDCCH, a physical control format indicator channel PCFICH, a physical hybrid automatic repeat request indicator channel PHICH, and a physical downlink shared channel PDSCH.

Based on the foregoing embodiment, the system information is at least one of a master information block MIB, a master information block of a new UE category, a master information block of a new UE type, a master information block of coverage-enhanced UE, a master information block of delay-tolerant UE, and a machine type communication master information block MTC MIB; and

the first physical channel is a physical broadcast channel PBCH carrying the system information, and/or an enhanced PBCH carrying the system information.

Further, based on the foregoing embodiment, the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and

the first physical channel is a physical downlink shared channel PDSCH carrying the system information, and/or an enhanced PDSCH carrying the system information.

Based on the foregoing embodiment, the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SIB; and

the first physical channel is a physical downlink control channel PDCCH carrying the DCI, and/or an enhanced PDCCH carrying the DCI.

FIG. 8 is a schematic structural diagram of user equipment according to an embodiment of the present invention. As shown in FIG. 8, the user equipment includes a receiver 801 and a processor 802, where

the receiver 801 is configured to receive a first physical channel in multiple preset subframes in a radio frame, where the multiple preset subframes include at least a subframe 0 and a subframe 5, the first physical channel carries first information, and the first information is system information or scheduling information of system information; and

the processor 802 is configured to determine the first information according to the received first physical channel.

In the user equipment provided in this embodiment of the present invention, a first physical channel is received in multiple preset subframes in a radio frame, where the multiple preset subframes include at least a subframe 0 and a subframe 5, the first physical channel carries first information, and the first information is system information or scheduling information of system information; then, the first information is determined according to the received first physical channel, so as to decrease detection complexity and power consumption of the UE.

Based on the foregoing embodiment, the multiple preset subframes further include either of a subframe 1 and a subframe 6.

Optionally, based on the foregoing embodiment, the multiple preset subframes further include the subframe 1 and the subframe 6.

Based on the foregoing embodiment, the multiple preset subframes further include at least one of a subframe 3, a subframe 4, a subframe 7, a subframe 8, and a subframe 9.

Optionally, based on the foregoing embodiment, the multiple preset subframes further include the subframe 3, the subframe 4, the subframe 7, the subframe 8, and the subframe 9.

Based on the foregoing embodiment, the multiple preset subframes include all downlink subframes in a radio frame that is determined by a pre-stipulated uplink-downlink configuration; or

the multiple preset subframes further include all special subframes in a radio frame that is determined by a pre-stipulated uplink-downlink configuration; or

the multiple preset subframes further include all downlink subframes and special subframes, except a subframe 0 and a subframe 5, in a radio frame that is determined by a pre-stipulated uplink-downlink configuration; or

the multiple preset subframes are all subframes in the radio frame.

Further, based on the foregoing embodiment, that the multiple preset subframes further include all downlink subframes and special subframes, except a subframe 0 and a subframe 5, in a radio frame that is determined by a pre-stipulated uplink-downlink configuration includes:

the multiple preset subframes further include all downlink subframes and special subframes, except a subframe 0 and a subframe 5, in a radio frame that is determined by a pre-stipulated uplink-downlink configuration 5, that is, in addition to the subframe 0 and the subframe 5, the multiple preset subframes further include a subframe 1, a subframe 3, a subframe 4, a subframe 6, a subframe 7, a subframe 8, and a subframe 9.

Based on the foregoing embodiment, a configuration of the special subframe is a pre-stipulated special subframe configuration.

Further, based on the foregoing embodiment, for a downlink normal cyclic prefix, the configuration of the special subframe is a pre-stipulated special subframe configuration 4, and for a downlink extended cyclic prefix, the configuration of the special subframe is a pre-stipulated special subframe configuration 3.

Based on the foregoing embodiment, the special subframe is the subframe 1 and/or the subframe 6.

Based on the foregoing embodiment, the receiver 801 is further configured to receive a second physical channel, where an uplink-downlink configuration of a radio frame for transmitting the second physical channel is different from an uplink-downlink configuration of the radio frame for transmitting the first information, and/or, a special subframe configuration of a special subframe in the radio frame for transmitting the second physical channel is different from a special subframe configuration of a special subframe in the radio frame for transmitting the first information; and the second physical channel includes any one of a physical downlink control channel PDCCH, an enhanced physical downlink control channel ePDCCH, a physical control format indicator channel PCFICH, a physical hybrid automatic repeat request indicator channel PHICH, and a physical downlink shared channel PDSCH.

Based on the foregoing embodiment, the system information is at least one of a master information block MIB, a master information block of a new UE category, a master information block of a new UE type, a master information block of coverage-enhanced UE, a master information block of delay-tolerant UE, and a machine type communication master information block MTC MIB; and

the first physical channel is a physical broadcast channel PBCH carrying the system information, and/or an enhanced PBCH carrying the system information.

Based on the foregoing embodiment, the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information new MTC SI; and

the first physical channel is a physical downlink shared channel PDSCH carrying the system information, and/or an enhanced PDSCH carrying the system information.

Based on the foregoing embodiment, the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SIB; and

the first physical channel is a physical downlink control channel PDCCH carrying the DCI, and/or an enhanced PDCCH carrying the DCI.

Based on the foregoing embodiments, an embodiment provides a communications system, including the information transmission apparatus in a TDD system shown in FIG. 5 and the information determining apparatus in a TDD system shown in FIG. 6.

Based on the foregoing embodiments, an embodiment provides a communications system, including the base station shown in FIG. 7 and the user equipment shown in FIG. 8.

Persons of ordinary skill in the art may understand that all or some of the steps of the method embodiments may be implemented by a program instructing related hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. An information transmission method in a TDD system, comprising:
mapping first information onto multiple preset subframes in a radio frame, wherein the multiple preset subframes comprise at least a subframe 0 and a subframe 5, and the first information is system information or scheduling information of system information; and
sending a first physical channel to user equipment (UE), wherein the first physical channel carries the first information.

2. The method according to claim 1, wherein the multiple preset subframes further comprise at least one of a subframe 1 and a subframe 6.

3. The method according to claim 1, wherein the multiple preset subframes further comprise at least one of a subframe 3, a subframe 4, a subframe 7, a subframe 8, and a subframe 9.

4. The method according to claim 1, wherein
the multiple preset subframes are all downlink subframes in a radio frame that is determined by a pre-stipulated uplink-downlink configuration; or
the multiple preset subframes further comprise all special subframes in a radio frame that is determined by a pre-stipulated uplink-downlink configuration; or
the multiple preset subframes further comprise all downlink subframes and special subframes, except a subframe 0 and a subframe 5, in a radio frame that is determined by a pre-stipulated uplink-downlink configuration; or
the multiple preset subframes are all subframes in the radio frame.

5. The method according to claim 1, wherein the system information is at least one of a master information block MIB, a master information block of a new UE category, a master information block of a new UE type, a master information block of coverage-enhanced UE, a master information block of delay-tolerant UE, and a machine type communication master information block MTC MIB; and
the first physical channel is a physical broadcast channel PBCH carrying the system information, and/or an enhanced PBCH carrying the system information.

6. The method according to claim 1, wherein the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and
the first physical channel is a physical downlink shared channel PDSCH carrying the system information, and/or an enhanced PDSCH carrying the system information.

7. The method according to claim 1, wherein the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SI; and
the first physical channel is a physical downlink control channel PDCCH carrying the scheduling information, and/or an enhanced PDCCH carrying the scheduling information.

8. An information determining method in a TDD system, comprising:
receiving a first physical channel in multiple preset subframes in a radio frame, wherein the multiple preset subframes comprise at least a subframe 0 and a subframe 5, the first physical channel carries first information, and the first information is system information or scheduling information of system information; and
determining the first information according to the received first physical channel.

9. The method according to claim 8, wherein the multiple preset subframes further comprise at least one of a subframe 1 and a subframe 6.

10. The method according to claim 8, wherein the multiple preset subframes further comprise at least one of a subframe 3, a subframe 4, a subframe 7, a subframe 8, and a subframe 9.

11. The method according to claim 8, wherein
the multiple preset subframes are all downlink subframes in a radio frame that is determined by a pre-stipulated uplink-downlink configuration; or
the multiple preset subframes further comprise all special subframes in a radio frame that is determined by a pre-stipulated uplink-downlink configuration; or
the multiple preset subframes further comprise all downlink subframes and special subframes, except a subframe 0 and a subframe 5, in a radio frame that is determined by a pre-stipulated uplink-downlink configuration; or
the multiple preset subframes are all subframes in the radio frame.

12. The method according to claim 8, wherein the system information is at least one of a master information block MIB, a master information block of a new UE category, a master information block of a new UE type, a master information block of coverage-enhanced UE, a master information block of delay-tolerant UE, and a machine type communication master information block MTC MIB; and
the first physical channel is a physical broadcast channel PBCH carrying the system information, and/or an enhanced PBCH carrying the system information.

13. The method according to claim 8, wherein the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and
the first physical channel is a physical downlink shared channel PDSCH carrying the system information, and/or an enhanced PDSCH carrying the system information.

14. The method according to claim 8, wherein the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SI; and
the first physical channel is a physical downlink control channel PDCCH carrying the scheduling information, and/or an enhanced PDCCH carrying the scheduling information.

15. A base station comprising:
a memory and a processor configured to execute a program stored in the memory, the program comprising instructions to map first information onto multiple preset subframes in a radio frame, wherein the multiple preset subframes comprise at least a subframe 0 and a subframe 5, and the first information is system information or scheduling information of system information; and
a transmitter, configured to send a first physical channel to user equipment UE, wherein the first physical channel carries the first information.

16. The base station according to claim 15, wherein the multiple preset subframes further comprise at least one of a subframe 1 and a subframe 6.

17. The base station according to claim 15, wherein the multiple preset subframes further comprise at least one of a subframe 3, a subframe 4, a subframe 7, a subframe 8, and a subframe 9.

18. The base station according to claim 15, wherein
the multiple preset subframes are all downlink subframes in a radio frame that is determined by a pre-stipulated uplink-downlink configuration; or
the multiple preset subframes further comprise all special subframes in a radio frame that is determined by a pre-stipulated uplink-downlink configuration; or
the multiple preset subframes further comprise all downlink subframes and special subframes, except a subframe 0 and a subframe 5, in a radio frame that is determined by a pre-stipulated uplink-downlink configuration; or
the multiple preset subframes are all subframes in the radio frame.

19. The base station according to claim 15, wherein the system information is at least one of a master information block MIB, a master information block of a new UE category, a master information block of a new UE type, a master information block of coverage-enhanced UE, a master information block of delay-tolerant UE, and a machine type communication master information block MTC MIB; and
the first physical channel is a physical broadcast channel PBCH carrying the system information, and/or an enhanced PBCH carrying the system information.

20. The base station according to claim 15, wherein the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and
the first physical channel is a physical downlink shared channel PDSCH carrying the system information, and/or an enhanced PDSCH carrying the system information.

21. The base station according to claim 15, wherein the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SI; and
the first physical channel is a physical downlink control channel PDCCH carrying the scheduling information, and/or an enhanced PDCCH carrying the scheduling information.

22. An user equipment comprising:
a receiver configured to receive a first physical channel in multiple preset subframes in a radio frame, wherein the multiple preset subframes comprise at least a subframe 0 and a subframe 5, the first physical channel carries first information, and the first information is system information or scheduling information of system information; and
a memory storing a program;
a processor configured to execute the program, the program comprising instructions to determine the first information according to the received first physical channel.

23. The user equipment according to claim 22, wherein the multiple preset subframes further comprise at least one of a subframe 1 and a subframe 6.

24. The user equipment according to claim 22, wherein the multiple preset subframes further comprise at least one of a subframe 3, a subframe 4, a subframe 7, a subframe 8, and a subframe 9.

25. The user equipment according to claim 22, wherein
the multiple preset subframes are all downlink subframes in a radio frame that is determined by a pre-stipulated uplink-downlink configuration; or
the multiple preset subframes further comprise all special subframes in a radio frame that is determined by a pre-stipulated uplink-downlink configuration; or
the multiple preset subframes further comprise all downlink subframes and special subframes, except a subframe 0 and a subframe 5, in a radio frame that is determined by a pre-stipulated uplink-downlink configuration; or
the multiple preset subframes are all subframes in the radio frame.

26. The user equipment according to claim 22, wherein the system information is at least one of a master information block MIB, a master information block of a new UE category, a master information block of a new UE type, a master information block of coverage-enhanced UE, a master information block of delay-tolerant UE, and a machine type communication master information block MTC MIB; and
the first physical channel is a physical broadcast channel PBCH carrying the system information, and/or an enhanced PBCH carrying the system information.

27. The user equipment according to claim 22, wherein the system information is at least one of a system information block type 1 SIB1, a system information block type 2 SIB2, system information SI, a machine type communication system information block type 1 MTC SIB1, a machine type communication system information block type 2 MTC SIB2, machine type communication system information MTC SI, system information of a new UE category, system information of a new UE type, system information of low-cost UE, system information of coverage-enhanced UE, system information of delay-tolerant UE, and new machine type communication system information NEW MTC SI; and
the first physical channel is a physical downlink shared channel PDSCH carrying the system information, and/or an enhanced PDSCH carrying the system information.

28. The user equipment according to claim 22, wherein the scheduling information is at least one of downlink control information DCI for scheduling the SIB1, DCI for scheduling the SIB2, DCI for scheduling the SI, DCI for scheduling the MTC SIB1, DCI for scheduling the MTC SIB2, DCI for scheduling the MTC SI, DCI for scheduling the system information of a new UE category, DCI for scheduling the system information of a new UE type, DCI for scheduling the system information of low-cost UE, DCI for scheduling the system information of coverage-enhanced UE, DCI for scheduling the system information of delay-tolerant UE, and DCI for scheduling the new MTC SI; and
the first physical channel is a physical downlink control channel PDCCH carrying the scheduling information, and/or an enhanced PDCCH carrying the scheduling information.
